(19) United States
(12) Patent Application Publication
(10) Pub. No.: US 2013/0290368 A1
(43) Pub. Date: Oct. 31, 2013

(54) BAYESIAN NETWORKS OF CONTINUOUS QUERIES

(71) Applicants: Qiming Chen, Cupertino, CA (US); Meichun Hsu, Los Altos Hills, CA (US)

(72) Inventors: Qiming Chen, Cupertino, CA (US); Meichun Hsu, Los Altos Hills, CA (US)

(21) Appl. No.: 13/458,955

(22) Filed: Apr. 27, 2012

(51) Int. Cl. G06F 17/30

(52) U.S. Cl. 707/769; 707/E17.014

(57) ABSTRACT

Nodes of a Bayesian network can be respectively associated with continuous queries. In response to a result of one of the continuous query changing, the continuous queries that are associated with nodes in the Bayesian network that are descendant of a node associated with the changed continuous query are evaluated.

### BACKGROUND

People are becoming increasing connected to information systems such as the Internet and rely on continuous event analytics in their work and life. This has given rise to a need of providing Continuous analytics as a Service (CaaaS). For some uses, the results from such analytics need to be easily manageable, for example, to be downloadable to the mobile devices or devices having relatively modest processing power.

A Bayesian network, belief network, or directed acyclic graphical model is a probabilistic model that employs a directed acyclic graph (DAG) to represent a set of random variables and their conditional dependencies. Bayesian networks have particularly been used in computer systems such as expert systems that perform artificial reasoning systems. For example, a Bayesian network could represent the probabilistic relationships between diseases and symptoms, and given a set of symptoms, a computer system that is based on that Bayesian network can be used to compute the probabilities of various diseases being responsible for those symptoms.

### BRIEF DESCRIPTION OF THE DRAWINGS

FIG. 1 shows a Bayesian network employing continuous querying for complex event processing.

FIG. 2 is a block diagram of a computing system implementing complex event processing through a Bayesian network of continuous queries.

FIG. 3 is a flow diagram of a process for complex event processing through a Bayesian network of continuous queries.

Use of the same reference symbols in different figures indicates similar or identical items.

### DETAILED DESCRIPTION

Complex event processing (CEP) can be used to process events from an event cloud, identify meaningful events, analyze the impact of the events, and take or suggest subsequent action. For example, a computer system, e.g., a personal computer, a laptop computer, a pad computer, or a smart phone, performing CEP may glean from an event cloud a set of events including: 1.) bells ringing at a church; 2.) a crowd of people in front of the church; and 3.) rice being thrown at two people leaving the church. The CEP system may include a rule that produces a result or conclusion indicating that a wedding has just occurred. The CEP system may further take some action appropriate for the result or conclusion reached. CEP systems can be complex because the number of events processed and the number of possible outcomes may be large. For example, a rule for determining an outcome based on m Boolean variables or events may have 2^{m} possible outcomes. For a reasonable number of variables m, a CEP system can include a table of outcomes indexed by the values of the variables. However, such a table becomes less practical when the variables have a large number of possible values or are subject to uncertainties so that only probabilistic results can be generated. As described herein, a CEP system can employ a Bayesian network of continuous queries to replace use of a table. The tree structure of the Bayesian network may make CEP more computationally tractable in current computing systems.

A Bayesian network (BN) is a probabilistic graphical model, e.g., a directed acyclic graph model, that represents a set of variables and conditional dependencies of the variables. A directed acyclic graph (DAG) for a BN can include a collection of nodes and directed edges, where each edge connects one node to another and the set of edges are such that no sequence of edges starting at one node in the DAG loops back to that node. For a BN, the nodes of the DAG correspond to random variables and may represent observable quantities, latent variables, unknown parameters, or hypotheses. Each edge in the DAG represents a conditional dependency between a parent node and a child node that the edge connects. Nodes which are not connected in the DAG of a BN can represent variables that are conditionally independent of each other. Naïve Bayesian networks are BNs in which the presence (or absence) of a particular feature or class of an input to the naïve BN is independent of the presence (or absence) of any other feature or class of any other input. Naïve Bayesian networks may be simpler to develop or employ.

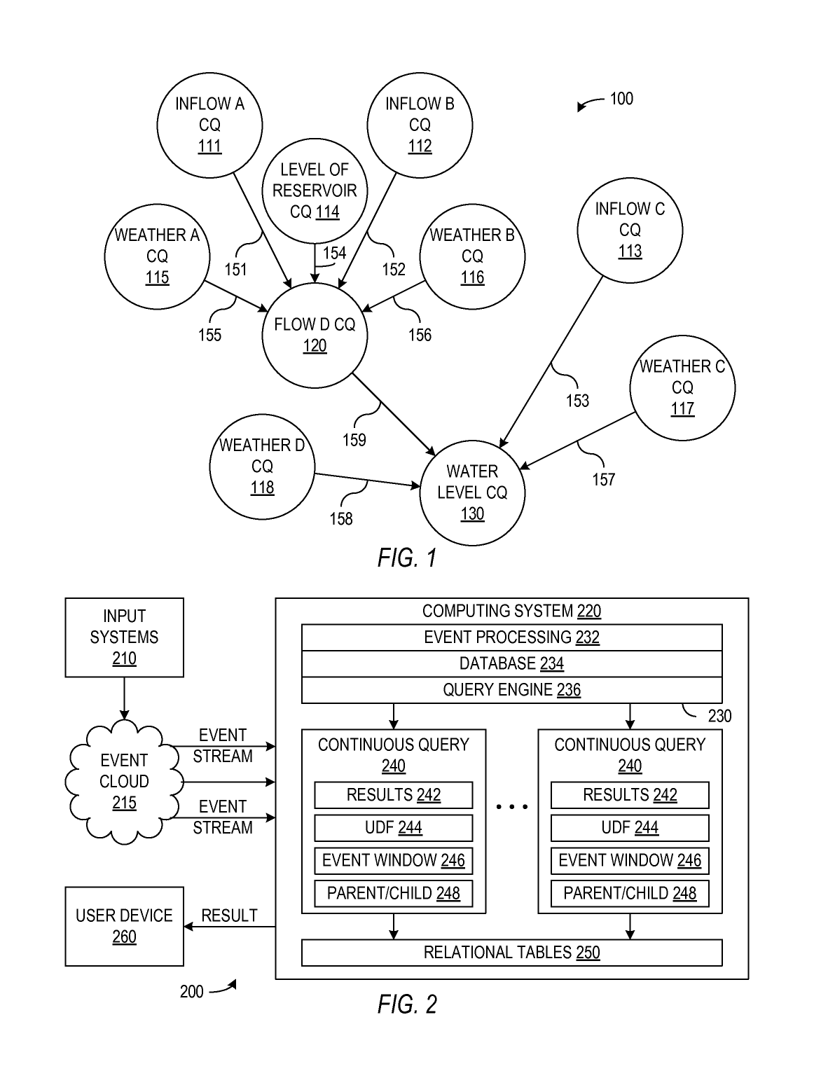

FIG. 1 shows an example of a Bayesian network 100 including nodes 111 to 118, 120, and 130, connected in a tree structure by directed edges 151 to 159. Each node of BN 100 corresponds to a variable having values or classifications that depend on dynamic events, but the value or classification of a node may not be characterized solely by dynamic events. In particular, the features for classification for some nodes may be associated with the collective behavior of multiple events. Further, a node may require integration or combination of dynamic events, static knowledge, and the probabilities, results, or classifications of other nodes in BN 100. As described further below, each node of BN 100 may be associated with a corresponding continuous query (CQ) that may incorporate User Defined Functions (UDFs) that depend on dynamic events as continuously received and past events that may be collected in a relational database. A continuous query is a query that can be issued once and evaluated repeatedly or continuously by a data management system until the query is expressly terminated. Accordingly, the result of a continuous query may change over time in response to arriving events, and a history table for results from a continuous query may be kept. Without loss of generality, the term “results” of a query or a node is sometimes used herein to refer to the value, classification, or probability distribution reflecting a state or instance of the query or node, e.g., at a specific time. Further, BN 100 may be a probability model and can be viewed as having interpretations associated with instances of the probability model that are respectively associated with bounds to the values of certain random variables. An interpretation of BN 100 is effectively a snapshot of a probabilistic network. With this scheme, a BN may underlie an infinite sequence of interpretations triggered by unbounded events. Time-window semantics can be used as described further below to punctuate the input events and to delimit the life-span of each interpretation. Such window semantics can be implemented based on a granule-based CQ model as described further below.

Nodes 111 to 118 of BN 100 are root nodes in that nodes 111 to 118 are not descendants of any other nodes in BN 100. Each of root nodes 111 to 118 is associated with a continuous query that may be constructed, for example, using a Structured Query Language (SQL) or Continuous Query Language (CQL) query with or without user defined functions. The continuous queries can be executed in a suitable data management or server system, e.g., by an extended database query engine. As an illustration, root nodes 111, 112, and 113 may represent single events such as measurements of water flow at respective locations and times in the modeled watershed, and continuous queries corresponding to nodes 111 to 113 may retrieve the correct measurements from an event stream, an event cloud, a database, or other data collection including measurement events. Other root nodes 114 to 118 of BN 100 may correspond to latent variables that don't have results set by a single event. For example, node 114 may model a feature such as a dam that limits a water flow, and the results of the CQ associated with node 114 may be a prediction of a future water flow based on factors such as current water levels or predicted rainfall. In FIG. 1, each of root nodes 115 to 118 may similarly be a latent variable such as a prediction of rainfall in a specified area during a specified time interval, so that results associated with an instance of the continuous query associated with node 115, 116, 117, or 118 may depend on multiple events. For example, queries corresponding to nodes 115 to 118 may involve calculations involving events such as measurements of temperature or barometric pressure at specific places and times or information such as the date and time. The results of the CQs associated with nodes 115 to 118 may, for example, include probabilities that rainfall in an area during a time interval or window is in classes corresponding to specific ranges of rainfall.

Nodes 120 and 130 are non-root nodes. In particular, node 120 is a child node of nodes 111, 112, 114, 115, and 116 and represents a variable having results that depend on the results of nodes 111, 112, 114, 115, and 116. Node 120 may, for example, represent a water flow that is fed by the water flows associated with nodes 111 and 112, water releases associated with node 114, and rainfall associated with nodes 115 and 116. A continuous query associated with node 120 thus may employ or operate on results associated with nodes 111, 112, 114, 115, and 116. Node 130 is similarly a child node but depends directly or indirectly on all other nodes in BN 100. Node 130 may represent a prediction for a water level at a location furthest downstream in the modeled watershed.

Each node 111 to 118, 120, and 130 of BN 100 is associated with a CQ as described above. When BN 100 is active, each root node 111 to 118 may be a sink of a CEP result, which may be conducted through an SQL or a CQL query. The results of each root node 111 to 118 may be sent as data streams to any descendant nodes or stored in tables accessible to the descendant nodes 120 and 130. Each non-root node 120 or 130 may similarly be equipped with a CQ for reading the state of its parent nodes to make an inference, which in turn may be provided to a descendant node, e.g., from node 120 to node 130, or as a result to be acted on or used elsewhere. In particular, with the above mechanisms, a resulting system based on BN 100 may continuously generate time-window oriented snapshots which may be stored in relation tables representing predicted states, and the relation tables may be made accessible by database applications such as R applications.

BN 100 can provide probabilistic reasoning in determining values, e.g., for water levels associated with node 130. Probabilistic reasoning may simply mean computing the marginal distribution for a set of variables, or the conditional probability distribution for a set of variables given evidence. CEP may, for example, use BN 100 to calculate a probability of reaching a flood stage at a particular time or times. Intuitively each node of BN 100 represents a random variable that may be instantiated by the state (or classified to a class) reached as a result of the occurrence of one or more events. The state may be a set of probabilities for possible values or if one probability is 100%, i.e., not fuzzy, a definite value or values, and the relationship between BN 100 and CEP is that the probabilities of child nodes may be updated through a probability propagation procedure from the parent nodes. At a specific time, a snapshot of BN 100 may represent an influence network snapshot for the prediction purpose. Although BN 100, for illustration of a specific example, is described here in terms of a specific model of a watershed area and illustrates a relatively simple application of a Bayesian network to analysis that determines or predicts characteristics such as water levels or water flows at locations in the watershed. More generally, Bayesian networks have nearly limitless applications such as modeling physical systems, modeling decisions or diagnostic processes, or organization or classification of data generally and the principles described for BN 100 may apply to other Bayesian networks.

A characteristic such as the water level at a particular time and location in a watershed (e.g., as predicted by node 130) may be expected to depend on the values of upstream variables such as the inflows (e.g., nodes 111, 112, and 113), possible flow restrictions (e.g., node 114), and contributions from weather (e.g., node 115, 116, 117, and 118) at specific times. If the ultimate result desired from BN 100 is from node 130, each of the other nodes may accordingly be restricted to depend only on events within specific time windows or time granules needed for the ultimate result. Queries for nodes 111 to 118, 120, and 130 may thus be granule-based continuous queries such as described by Qiming Chen, Meichun Hsu, and Hans Zeller, “Experience in Continuous analytics as a Service (CaaaS),” EDBT'2011, which is hereby incorporated by reference in its entirety. Chen et al. particularly describe how a query engine can be adapted to perform granule-based continuous queries in cycles. Each node in BN 100 that is associated with a time-window oriented CQ can then be run cycle by cycle, e.g. minute by minute, for retrieving or processing the events falling in the time-boundary for the CQ and the current cycle. The whole active infrastructure of BN 100 can thus be synchronized by the time-windowing criteria. Such cycle or granule-based behavior may be implemented through user-defined functions in queries otherwise represented using query languages that do not provide for such behavior.

The topology of BN 100 may be such that non-root nodes 120 and 130 only directly depend on results from other nodes or such that non-root node 120 or 130 directly depends on events, e.g., from the event cloud or as collected in a database. If all non-root nodes 120 and 130 only directly depend on results from other nodes, evaluation of BN 100 would only require access to events for the evaluation of the continuous queries associated with root nodes 111 to 118, and node 120 and 130 can be performed without such access.

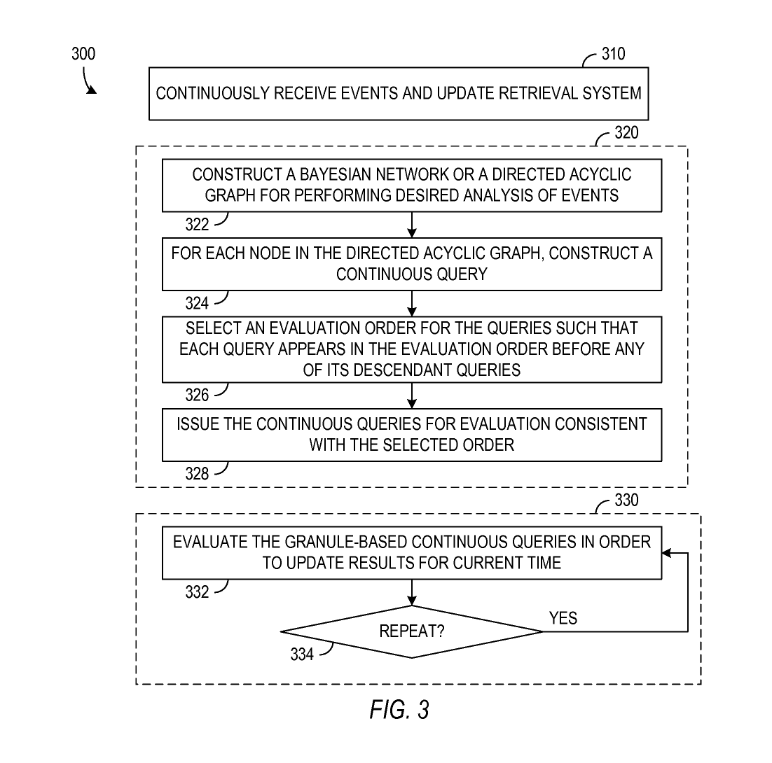

FIG. 2 illustrates a system 200 which may employ complex event processing based on a Bayesian network to provide continuous analytics as a service. System 200 includes input systems 210 that generate events forming an event cloud 215. Input systems 210 may include a variety of data sources such as sensors, static data storage containing documents or other information, and devices conveying human input, action, or instructions that may be interpreted as events. Each event may include related information such as a measurement or other data, a location at which the measurement or data was obtained, and a time at which the measurement or data was obtained. A computing system 220 can continuously process and analyze the events. In particular, computing system 220 can execute a data management system 230 that can include a data-stream management system or include similar event processing system 232. As events become available, event processing systems 232 may collect the events from event cloud 215 into a database 234 or pass events to a query engine 236 that executes continuous queries 240. Continuous queries 240 are continuous in the sense that query engine 236 repeatedly executes each continuous query 240 until that query 240 is deactivated, for example, by user action. Each execution of a continuous query 240 may be triggered by a new event or a changed result on which the continuous query 240 depends or may commence with some specified timing or in response to some other occurrence such as a coordinating system sending an instruction or query engine 236 completing some task. Although query engine 236 is shown as a single block in FIG. 3, query engine 236 may include multiple query engines that may run on different machines or sockets to respectively execute one or more of continuous queries 240. In such an implementation, query engine 236 may further include a coordinating system that communicates with and coordinates the separate query engines to execute continuous queries 240 at appropriate times on in an appropriate order.

Data management system 230 may integrate stream processing and database management and provide both streaming events and database 234 to query engine 236 or continuous queries 240. In particular, data management system 230 may continue to execute continuous queries 240 over time using database 234 and new events as they arise, and results 242 of continuous queries 240 may be updated as each new event appears. Further, data management system 230 may incorporate results 242 from queries 240 in database 234 and update database 234 when particular results 242 change. Thus, database 234 provides one possible mechanism for passing results 242 from a continuous query 240 associated with a node to continuous queries 240 associated with descendent nodes.

Queries 240 and particularly the process or calculation involved in generating results 242 for each continuous query 240 may be defined using a standard query language or may further involve evaluation of one or more user defined functions (UDFs) 244. For example, UDFs 244 may be used to combine a series of related events and handle statistical results associated with the possible probabilistic nature of at least some of continuous queries 240. Each continuous query 240 may also be associated with an event window 246 that temporally limits the events that are used in determination of results.

Continuous queries 240 may be defined and related according to a Bayesian network created to analyze the events in a user specified manner, and data fields 248 associated with each continuous query 240 can identify relationships that the Bayesian network defines among continuous queries 240. In particular, each continuous query 240 may correspond to a given node in a particular Bayesian network, and data fields 248 identify any other continuous queries 240 that correspond to nodes that are parent or child nodes of the given node in the Bayesian network. In general, each continuous query 240 will use results 242 from the continuous queries 240 that correspond to parent nodes in the Bayesian network. Results 242 from continuous queries 240 can be organized to produce relational tables 250 representing and relating the results of one or more of queries 240, and a relatively low power user device 260 can use the relational tables 250 to provide the analyzed information to a user in a user-friendly format.

System 200 can be implemented using a wide range of different hardware configurations that can partition computing and storage tasks in different ways. For example, computing system 220 may be a more powerful or distributed computing system including one or more servers, and user device 260 may be a computing system such as a personal computer, laptop computer, pad computer, or smart phone that is connected to computing system 220 through a network such as the Internet. In such a configuration, computing system 220 may provide most of the required processing and storage. As illustrated, computing system 220 includes processors that execute code implementing data management system 230 and that have data storage for event database 234 and relational tables 250. Continuous queries 240, which may be program objects that access specific information from data management system 230 or event database 234, may be implemented or executed in computing system 220 or elsewhere. In particular, continuous queries 240 may at least partially be executed in user device 260. Relational tables 250 could similarly be stored in computing system 220 or stored in data storage system in user device 260. In still another implementation, computing system 220 and user device 260 may consist of a single computer that performs the functions of both system 220 and device 260.

FIG. 3 illustrates a process 300 that integrates Bayesian network based dynamic probabilistic reasoning with continuous queries. Process 300 includes three sub-processes 310, 320, and 330 that to at least some extent may be performed asynchronously. An event management process 310 may be employed to continuously collect relevant events from an event cloud or one or more event streams. Event management process 310 may organize and store relevant events in a conventional manner to create an event database or pass events through to continuous query evaluation process 330. Even when the events are passed through, the events may, if necessary, be persisted, e.g., either in an event database or in data structures associated with the continuous queries. As described further below, event management process 310 may also trigger a re-evaluation of some or all of the continuous queries associated with a Bayesian network, for example, when a newly collected event may change a result of one or more of the continuous queries associated with the Bayesian network.

A modeling process 320 constructs a Bayesian network modeling a particular system, problem, or analysis having results that depend on specific events that process 310 handles. In particular, step 322 constructs a Bayesian network or directed acyclic graph for performing a desired analysis of events. The specific graph topology will depend on specific analysis to be performed, but as described above, the directed acyclic graph will generally include root nodes that depend on one or more events or combinations of events and non-root nodes that depend on the state or results of one or more other nodes. The non-root nodes may directly depend on the events in addition to depending on the results of from other nodes. Each node in the directed acyclic graph is associated with a continuous query that may be constructed in step 324. For example, the continuous query may be constructed using a query language such as SQL or CQL that is appropriate to the requirements of the database server or other system for accessing events from an event cloud or results from other nodes. Continuous queries constructed in step 324 may include a rule or user defined function for determining a time window containing the relevant events and user defined functions for calculations performed as part of the determination of the results of the continuous query.

The Bayesian network indicates relationships among the continuous queries, and for efficient and accurate evaluation, the continuous queries should be evaluated in an order such that for each node, the query associated with the node should be evaluated before any query associated with a descendant of the node. Step 326 selects an appropriate order for evaluation of the constructed queries, and step 328 issues the queries. For example, the constructed queries can be issued to a database server for continuous evaluation as events are collected. Since the queries are continuous, given two events or data items derived from events a followed by b, the continuous queries process a first, then b, so that evaluation of continuous queries corresponding to child nodes may be in response to a query corresponding to a parent node generating a result.

Evaluation process 330 evaluates the continuous queries associated with the Bayesian network. A step 332 represents one repetition of evaluation of the continuous queries. In one repetition of step 332, a subset or all of the queries associated with the Bayesian network are evaluated. The evaluation of each query may be time granule based in that the evaluation is based on the events occurring at times within a time window associated with the query. As noted above, an evaluation of the queries in step 332 may have an order established according to relationships of the respective nodes in the Bayesian network, so that for each non-root node, the query associated with the node will only be evaluated after the results from queries associated with all predecessor nodes are available. Parent nodes can store result data in memory that is accessible to successor nodes or pass results data to child nodes as data streams. For example, one implementation of process 330 tracks the state transitions of the dynamic BN along the advance of the time windows, e.g. minute by minute, and triggers evaluation of appropriate queries when state transitions occur.

Evaluation in one implementation of step 332 of the queries associated with the Bayesian network is performed periodically according to a fixed period, e.g., once each minute or other time interval, which may be selected according to the rate of change of relevant events. Alternatively, the evaluation of the queries in step 332 may start at variable intervals, for example, when triggered by detection of a new event that may change results of at least one of the queries. In either case, evaluation of queries in step 332 may proceed in the order selected in modeling process 320 and evaluate all of the queries associated with the Bayesian network or just the queries having results that may change. A decision step 334 represents a possible delay between repetitions of evaluation step 332. For example, a delay may occur in order to start evaluation step 332 at fixed times or may result if the evaluation only starts in response to a triggering event. Alternatively, step 332 may be continuously repeated without any significant delay between the end of one repetition and the start of the next repetition. With the above mechanisms, process 300 can continuously generate time-window oriented BN snapshots which may be stored in relational tables representing predicted states, and the relational tables may be accessible by database applications such as R applications running on a user device.

Some processes and systems described above can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading of data and executable instructions.

Although particular implementations have been disclosed, these implementations are only examples and should not be taken as limitations. Various adaptations and combinations of features of the implementations disclosed are within the scope of the following claims.

What is claimed is:

1. A method comprising:
processing an event stream in a computer system;
associating nodes of a Bayesian network respectively with a plurality of continuous queries that depend on events from the event stream; and
evaluating the continuous queries in the computer system, wherein in response to a first of the continuous queries having a result change, each of the continuous queries that are associated in the Bayesian network with nodes that are descendants of a node associated with the first continuous query are evaluated.

2. The method of claim 1, wherein evaluating the continuous queries in response to a results change comprises for any node in the Bayesian network corresponding to a continuous query being evaluated, evaluating the continuous query associated with the node before evaluating any of the continuous queries that are associated with any descendant nodes of the node.

3. The method of claim 1, wherein for at least one of the continuous queries, evaluating that continuous query requires a plurality of events from the event stream.

4. The method of claim 3, wherein evaluating that continuous query comprises determining a result using only the events that are within a time window associated with that continuous query.

5. The method of claim 4, wherein using only the events that are within the time window associated with the continuous query comprises using multiple events that are within the time window in determining the result.

6. The method of claim 1, wherein:
the nodes of the Bayesian network include root nodes and non-root nodes;
evaluating the continuous queries associated with the root nodes includes processing a set of the events; and
evaluating the continuous queries associated with the non-root nodes includes processing results from one or more of the continuous queries.

7. The method of claim 6, wherein evaluating the continuous queries associated with the root nodes further comprises streaming results to one or more continuous queries associated with the non-root nodes.

8. The method of claim 6, wherein evaluating the continuous queries associated with the non-root nodes further comprises accessing memory in which a previously evaluated continuous query stored results.

9. The method of claim 1, wherein evaluating the continuous queries comprises transferring results between the continuous queries according to relationships of nodes in the Bayesian network.

10. A non-transient computer-readable media containing instructions that when executed by a computer system perform a process including:
processing an event stream in the computer system; and
evaluating a plurality of continuous queries that depend on events from the event stream, wherein:
the continuous queries are respectively associated with nodes of a Bayesian network; and
in response to a first of the continuous queries having a result change, the continuous queries that are associated in the Bayesian network with nodes that are descendants of a node associated with the first continuous query are evaluated.

11. The media of claim 10, wherein:
the nodes of the Bayesian network include root nodes and non-root nodes;
evaluating the continuous queries associated with the root nodes includes processing a set of the events; and
evaluating the continuous queries associated with the non-root nodes includes processing results from one or more of the continuous queries.

12. The media of claim 11, wherein evaluating the continuous queries associated with the root nodes further comprises streaming results to one or more continuous queries associated with the non-root nodes.

13. The media of claim 11, wherein evaluating the continuous queries associated with the non-root nodes further comprises accessing memory in which a previously evaluated continuous query stored results.

14. The media of claim 10, wherein evaluating the continuous queries comprises transferring results between the continuous queries according to relationships of nodes in the Bayesian network.

15. A computer system comprising:
a data management system including an event processing system and a query evaluation system; and
a plurality of continuous queries that depend on events and are respectively associated with nodes of a Bayesian network, wherein:
the event processing system processes the events from an event cloud; and
the query engine executes the continuous queries in an order selected based on the Bayesian network.

16. The system of claim 15, further comprising storage containing a database constructed by the data management system, wherein the query evaluation system executes the continuous queries based on data from the database and new events passed through by the event processing system.

17. The system of claim 16, wherein the database includes prior events processed by the event processing system.

18. The system of claim 17, wherein the database further includes results from execution of the continuous queries.

19. The system of claim 15, further comprising storage containing relational tables representing results of the continuous queries.
